(19) United States
(12) Patent Application Publication
(10) Pub. No.: US 2007/0034572 A1
(43) Pub. Date: Feb. 15, 2007

(54) Low pressure anion chromatographic apparatus and method having two or more eluents

(75) Inventors: Hiroshi Oh, Cincinnati, OH (US); Victorio Tan Wee, Cincinnati, OH (US); Xin-shen Zhang, Chengdu (CN)

Correspondence Address: THE PROCTER & GAMBLE COMPANY;INTELLECTUAL PROPERTY DIVISION, WINTON HILL BUSINESS CENTER - BOX 161, 6110 CENTER HILL AVENUE, CINCINNATI, OH, 45224, US

(73) Assignee: The Procter & Gamble Company, Cincinnati, OH (US)

(21) Appl. No.: 11/200,441

(22) Filed: Aug. 9, 2005

(51) Int. Cl. B01D 15/08

(52) U.S. Cl. 210/656; 422/70; 210/198.2; 436/161

(57) ABSTRACT

A low pressure anion chromatography apparatus that includes a first eluent reservoir that contains a first eluent, a second eluent reservoir that contains a second eluent, and a valve for switching flow between the first and the second eluent reservoirs. The low pressure anion chromatography apparatus also has a low pressure pump, an injector, an anion exchange column, and a detector. The low pressure pump, the injector, the anion exchange column, the detector and the first and second eluent reservoirs are in fluid communication with one another through a series of fluid conduits. A method of using the low pressure anion chromatography apparatus is also provided. The use of two or more eluents allows for a broader range of anions to be detected with a relatively inexpensive low pressure chromatography system.

### FIELD OF THE INVENTION

The present invention relates to an apparatus and method for low pressure anion chromatography for the analysis of anions. The present apparatus and methods employ an analytical procedure that uses two or more different eluents that allows for the analysis of more anions than in a conventional low pressure ion chromatography system.

### BACKGROUND OF THE INVENTION

In general, low pressure chromatography is a known art, and there are many benefits to low pressure chromatography over high pressure chromatography. But high pressure chromatography has one distinct advantage, and that is, it allows for a broader range of ions to be analyzed from one sample. More specifically, high pressure chromatographic systems can measure more ions within a given sample than a low pressure chromatography system can. Low pressure chromatography has been limited by the affinity of certain ions to the eluent used. That is, certain eluents allow for the detection of some ions, but not all ions. And the low pressure chromatography systems known to the art are all single stage systems, that is, they employ only one eluent per sample. Thus, to detect all of the ions in a given sample, it has been necessary to test a given material multiple times with different eluents to determine the existence and amount of all ions. This is a labor-intensive process, and may even require multiple chromatographic systems. And these problems are especially acute when measuring anions.

A low pressure chromatography system for measuring cations is described in U.S. Pat. No. 5,098,563, which issued to Zhang Xin-shen, on Mar. 24, 1992. But the apparatus and method taught in the Zhang Xin-shen patent is limited to the measurement of cations and it is a single eluent system. Moreover, Zhang Xin-shen published an article with Xiaoping Jiang, in the Journal of Chromatography A, 671 (1994) 23-28, wherein the analysis of both cations and anions is discussed. But none of the low pressure hromatography systems described in these publications can analyze for a broad range of ions in a single sample.

While high pressure systems, for example, those described in the Journal of Chromatography A, 706 (1995) 199-207, by Umali et al., solve some of the problems associated with low pressure chromatography, high pressure systems have many disadvantages. Specifically, because of the higher pressure of the chromatography column and ancillary equipment, leakage often occurs around seals and joints. Moreover, the cost of a high pressure system can by ten times or more the cost of a low pressure system. This added cost is due in part to the more sophisticated seals and joints, thicker and higher quality materials of construction, and because high pressure pumps are far more expensive than their low pressure counterparts. Thus, low pressure chromatography systems are far less expensive, less complicated and have fewer mechanical problems than high pressure systems.

For these reasons there exists a need for improved low pressure anion chromatography systems that can analyze for a broad spectrum of anions while maintaining the economic and mechanical benefits of a low pressure system. This need and others, are met by the low pressure anion chromatography systems of the present invention.

### SUMMARY OF THE INVENTION

In one aspect, the present invention comprises a low pressure anion chromatography apparatus comprising a first eluent reservoir containing a first eluent, a second eluent reservoir containing a second eluent, and a valve for switching flow between the first and the second eluent reservoirs. The low pressure anion chromatography apparatus further comprises a low pressure pump, an injector, an anion exchange column, and a detector. The low pressure pump, the injector, the anion exchange column, the detector and the first and second eluent reservoirs are in fluid communication with one another through a series of fluid conduits.

In another embodiment of the present invention the anion exchange column of the low pressure ion chromatography apparatus analyzes for anions selected from the group consisting of F⁻, NO₃⁻, Cl⁻, Br⁻, SO₃²⁻, SO₄²⁻, PO₄³⁻, P₂O₇⁴⁻, P₃O₁₀⁵⁻ and mixtures thereof.

There is further provided herein a method of analyzing anions in a fluid. This method comprises the steps of injecting a sample fluid into an anion exchange column, using a low pressure pump, pumping a first eluent through the anion exchange column, switching from the first eluent to a second eluent using a valve and pumping the second eluent through the anion exchange column; and detecting the concentration of various anions in the sample fluid with a detector.

The present methods and apparatuses provide a substantial improvement over prior systems because a broader chromatogram of anions can be detected in one sample using the low pressure chromatography systems described herein. The present apparatuses and methods have excellent precision and sensitivity, and can detect anions in the parts per billion range. Moreover, the present systems provide these advantages while maintaining all of the cost and reliability advantages over high pressure chromatography equipment. As such, the present apparatuses and methods provide many unexpected and superior benefits over known low pressure anion chromatography systems.

### BRIEF DESCRIPTION OF THE DRAWINGS

While the specification concludes with claims particularly pointing out and distinctly claiming the invention, it is believed that the invention will be better understood from the following description of preferred embodiments which is taken in conjunction with the accompanying drawings in which:

FIG. 1 is a schematic representation of a low pressure anion chromatography apparatus according to the present invention; and

FIG. 2 is a chromatographic spectrum of anions analyzed by the low pressure anion chromatography apparatus of FIG. 1.

### DETAILED DESCRIPTION OF THE INVENTION

As used herein, low pressure chromatography means chromatography conducted in an anion exchange column at a pressure of less than about 500 psi and preferably less than 100 psi, and more preferably from about 20 to about 50 psi. The samples analyzed by the low pressure anion chromatography apparatus described herein form no part of this invention, but can include, for example, laundry detergents, toothpaste, food, skin care products, hair care products, and other consumer products that might comprise anions.

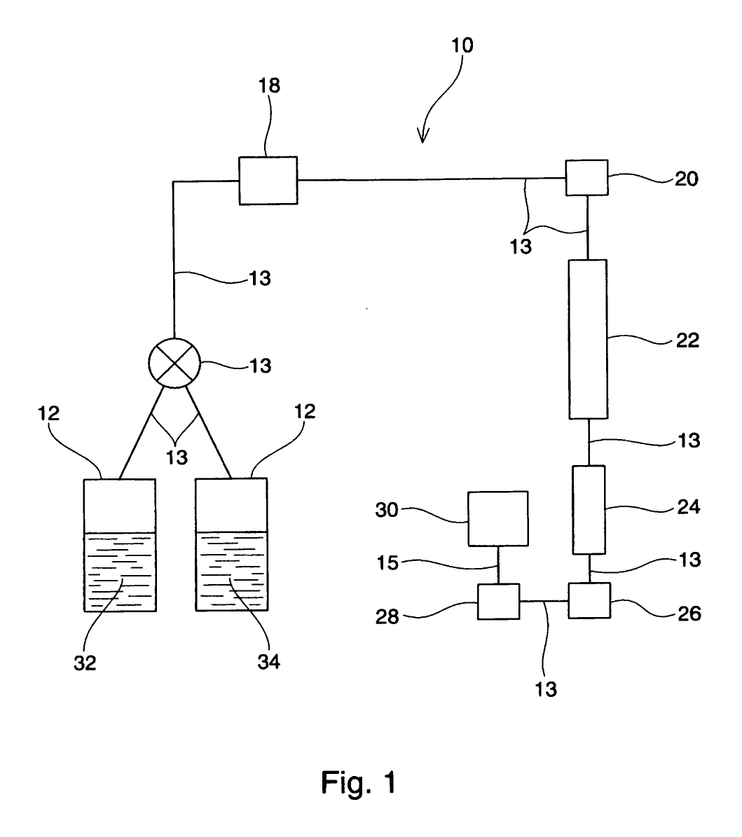

Referring now to FIG. 1, which is a schematic representation of a low pressure anion chromatography apparatus 10 according to the present invention. Low pressure anion chromatography apparatus 10 comprises a first eluent reservoir 12, a second eluent reservoir 14, a switching valve 16, a low pressure pump 18, a sample injector 20, an anion exchange column 22, a suppressor 24, a flow conductivity cell 26, a conductivity detector 28, and a workstation 30. First eluent reservoir 12 contains first eluent 32 and second eluent reservoir 14 contains second eluent 34. The majority of the component parts of low pressure anion chromatography apparatus 10 are in fluid communication with one another via fluid conduits 13. Workstation 30 is in electrical communication with conductivity detector 28 via electrical cable 15.

During operation, low pressure pump 18, pumps eluent from either first eluent reservoir 12 or second eluent reservoir 14 into anion exchange column 22. Switching valve 16 controls which of the eluent reservoirs is in use. While eluent is flowing through anion exchange column 22, a sample fluid is injected into column 22 by sample injector 20. Both the sample and the eluent travel through the column and before the sample has completely passed through the column, switching valve 16 switches the flow from one eluent to the other. The time that this switch takes place will depend on various factors, for example the flow rate of the eluent, the size of the sample, the size of the column, and the like. But the time that the switch should take place will be quite evident to those skilled in the art. When anions are no longer being detected with the first eluent, then it is time to switch to the second eluent.

More specifically, as the sample and the eluent flow together through column 22 they react chemically in a manner that separates the anions from their associated cations.

While still in solution, the anions flow from column 22 to suppressor 24, and then onto flow conductivity cell 26 and conductivity detector 28, which work in tandem to produce an electrical detection signal related to each anion detected. Suppressor 24 is used to help eliminate the strong signal associated with the large concentration of anions from the eluent such as OH⁻. The detection signal is sent to work station 30 where it can be displayed, printed, stored on an electronic medium or transferred to other electronic devices.

Eluents that are appropriate for use in the present low pressure chromatography systems include, but are not limited to, Na₂CO₃, and NaOH. Preferably, first eluent 32 is Na₂CO₃, at a concentration of from about 1.0×10⁻⁵ mole/liter to about 1.0 mole/liter and second eluent 34 is NaOH at a concentration of from about 1.0×10⁻⁶ mole/liter to about 0.5 mole/liter. Although the first and second eluents can be different chemical composition, they can also be the same chemical composition but in different concentrations. For example, the first eluent can be NaOH at a concentration of from about 1.0×10⁻⁶ mole/liter to about 0.1 mole/liter and the second eluent can be NaOH at a concentration of from about 1.0×10⁻² mole/liter to about 0.5 mole/liter. When the first and second eluents are the same chemical composition it is preferred that the concentration of the first eluent differ from the concentration of the second eluent by at least about 50%, preferably by at least about 80%, and more preferably by at least about 100%, on a mole/liter basis. It is understood that three or more different eluents can be used with the low pressure chromatography apparatuses and methods disclosed herein. “Different eluents” as used herein means that each eluent is a different chemical composition or the eluents can be the same chemically and differ in their respective concentrations. While the drawings and much of the description focuses on a low pressure chromatography system having only two eluents, the present invention is not so limited.

Retuning again to FIG. 1, wherein eluent reservoirs 12 and 14 can be any appropriate size and made of any material that can contain and is compatible with first eluent 32 and second eluent 34. As used throughout the following description of the component parts of low pressure anion chromatography apparatus 10, compatible materials include, but are not limited to, rubber, plastic, glass, metal, and the like.

Materials that resist corrosion, for example stainless steel, poly vinyl chloride, polyethylene, polypropylene, and Teflon are preferred. For example, eluent reservoirs 12 and 14 can be polyethylene bottles with a volume of from about 100 ml to about 10 liters. Such reservoirs are commonly available from chemical suppliers, such as Dionex Corporation. Likewise, switching valve 16 can be any flow regulating device that is compatible with the first and second eluents, and can stop the flow of one eluent while starting the flow of the other eluent. Preferably, switching valve 16 is automated, that is it automatically switches from one eluent to another based on a predetermined criteria. The predetermined criteria can be, for example, a set period of time, a preselected volume of one eluent, or a signal from the detector after a preselected anion has been detected. Switching valves are known, and examples include model SV2 manufactured by Laboratory of Analytical Equipment, Sichuan University, Chengdu, China, and model SV-3 valve manufactured by BIO-RAD Laboratories, Hercules, Calif., USA.

Low pressure pump 18 should be compatible with first eluent 32 and second eluent 34, and such pumps are known to the art and commercially available, for example, models LDB-M and LDB-H electronic peristaltic pumps manufactured by Dingshan Instrument Factory in Xiangshai Country, Zhejiang Province, PRC, and Bio Logic LP system manufactured by BIO-RAD Laboratories, Hercules, Calif., USA.

Injector 20, anion exchange column 22, suppressor 24, flow conductivity cell 26, and conductivity detector 28 should all be compatible with first eluent 32, second eluent 34, as well as the sample fluid (not shown). Injectors will be known to those skilled in the art and examples include model AJ1 manufactured by Laboratory of Analytical Equipment, Sichuan University, Chengdu, China, and model MV-6 injection valve manufactured by BIO-RAD Laboratories, Hercules, Calif., USA.

Columns suitable for use herein can be any appropriate size depending on the amount of sample material that will be analyzed, the flow rate of the eluents etc. Suitably sized columns can have an internal diameter of from about 0.2 cm to about 3 cm, with a height of from about 3 cm to about 30 cm, and a volume of from about 0.5 mili-liters to about 850 mili-liters. An example of a column that is appropriate for use as anion exchange column 22 in conjunction with low pressure anion chromatography apparatus 10 is C2 Anionic Exchange Column manufactured by Laboratory of Analytical Equipment, Sichuan University, Chengdu, China. The column is packed with and ion exchange resin that can be, for example, tetrabutylamonium salt. Other packing and resins will be known to those skilled in the art. An example of a suppressor is Anion Self-Regenerating suppressor ASRS manufactured by Dionex Corporation, Sunnyvale, Calif., USA. Examples of flow conductivity cells that are appropriate for use in the present low pressure anion chromatography apparatus include model CC1 manufactured by Laboratory of Analytical Equipment, Sichuan University, Chengdu, China, and model DS3 manufactured by Dionex Corporation, Sunnyvale, Calif., USA. Examples of conductivity detectors that are appropriate for use in the present low pressure anion chromatography apparatus include model CD1 manufactured by Laboratory of Analytical Equipment, Sichuan University, Chengdu, China, and model CD20 manufactured by Dionex Corporation, Sunnyvale, Calif., USA.

Fluid conduits 13 connect many of the various component parts of a low pressure anion chromatography apparatus 10. The conduits can be made of any compatible material as discussed above, and should be sized to achieve the desired flow rates through the various components. The individual sections of fluid conduit 13 can be made of different materials or they can all be the same. The selection of the fluid conduits and their materials of construction is within the skill of an artisan in the analytical chemical field.

Workstation 30 can be any electronic device capable of receiving signals from conductivity detector 28 and converting that signal into a detection output. The output can be stored directly into memory, relayed to a printing device, or visual monitor, or it can be used to regulate the flow of eluents as discussed above. Regardless, workstation 30 can be, for example, an IBM Personal Computer 350 with the software Model LPIC 1 manufactured by Laboratory of Analytical Equipment, Sichuan University, Chengdu, China.

The following is a non-limiting example of a low pressure anion chromatography apparatus and method according to the present invention.

### EXAMPLE I

Five laundry detergents are analyzed with a low pressure anion chromatography apparatus as described herein. Each of the detergents is dissolved in water to form a 1%, by weight, solution. The first eluent is Na₂CO₃ at a concentration of 1.0×10⁻³ mole/liter, and the second eluent is NaOH at a concentration of 8.0×10⁻² mole/liter. The anionic exchange column is operated at between 30 and 50 psi and the electric conductivity detector is set at 2 mv.

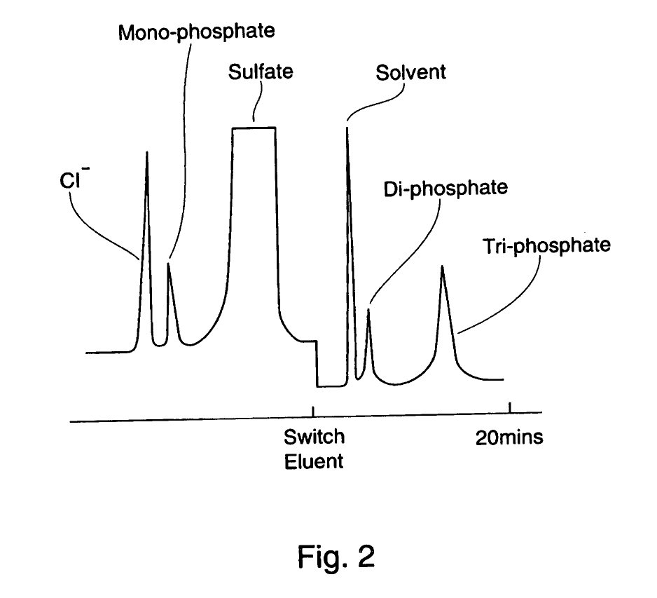

For each of the five tests, the eluent flows through the column at 1.2 ml/minute. 20 μl of the 1% detergent sample is injected into the eluent. The results of the tests are given in Table 1 below. Moreover, FIG. 2 is a chromatographic spectrum of anions analyzed from Detergent B. As can be seen in FIG. 2, shortly after the sulfate anions are detected the first eluent is stopped and the second eluent is pumped through the column. Without the second eluent, the diphosphate (P₂O₇⁴⁻) and triphosphate (P₃O₁₀⁵⁻) anions would not be detected.

| | SO₄²⁻ | PO₄²⁻ | PO₄²⁻ | PO₄²⁻ |
|---|---|---|---|---|
| Detergent | Wt. % | Wt. % | Wt. % | Wt. % |
| A | 31.1 | 0.3 | 1.4 | 16.7 |
| B | 35.2 | 1.0 | 5.0 | 15.5 |
| C | 37.7 | 1.0 | 4.6 | 14.0 |
| D | 25.0 | 1.3 | 5.0 | 11.5 |
| E | 35.5 | 1.3 | 3.2 | 21.6 |

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A low pressure anion chromatography apparatus comprising:
a first eluent reservoir containing a first eluent, a second eluent reservoir containing a second eluent, and a valve for switching flow between the first and the second eluent reservoirs;
a low pressure pump;
an injector;
an anion exchange column;
a detector; and
wherein the low pressure pump, the injector, the anion exchange column, the detector and the first and second eluent reservoirs are in fluid communication with one another through a series of fluid conduits.

2. The low pressure ion chromatography apparatus of claim 1, wherein the anion exchange column analyzes for anions selected from the group consisting of F⁻, NO₃⁻, Cl⁻, Br⁻, SO₃²⁻, SO₄²⁻, PO₄³⁻, P₂O₇⁴⁻, P₃O₁₀⁵⁻ and mixtures thereof.

3. The low pressure ion chromatography apparatus of claim 1, wherein the first eluent is Na₂CO₃ at a concentration of from about 1.0×10⁻⁵ mole/liter to about 1.0 mole/liter and the second eluent is NaOH at a concentration of from about 1.0×10⁻² mole/liter to about 0.5 mole/liter.

4. The low pressure ion chromatography apparatus of claim 1, wherein the first eluent is NaOH at a concentration of from about 1.0×10⁻⁶ mole/liter to about 0.1mole/liter and the second eluent is NaOH at a concentration of from about 1.0×10⁻⁶ mole/liter to about 0.5 mole/liter, and wherein the concentration of the first eluent differs from the concentration of the second eluent by at least about 50%, preferably by at least about 80%, and more preferably by at least about 100%, on a mole/liter basis.

5. The low pressure ion chromatography apparatus of claim 1, wherein the anion exchange column is operated at a pressure of less than about 500 psi and preferably less than 100 psi, and more preferably from about 20 to about 50 psi.

6. The low pressure ion chromatography apparatus of claim 1, three or more eluent reservoirs each containing a different eluent.

7. A method of analyzing anions in a fluid, the method comprising the steps of:
injecting a sample fluid into an a anion exchange column;
using a low pressure pump, pumping a first eluent through the anion exchange column;
switching from the first eluent to a second eluent using a valve and pumping the second eluent through the anion exchange column; and
detecting the concentration of various anions in the sample fluid with a detector.
